(19) United States
(12) Patent Application Publication
(10) Pub. No.: US 2008/0176053 A1
(43) Pub. Date: Jul. 24, 2008

(54) Gypsum Wallboard Containing Acoustical Tile

(75) Inventors: David Paul Miller, Lindenhurst, IL (US); Michael Scott Cunningham, Crown Point, IN (US); Patrick Desmond, Brooklyn, MI (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: United States Cypsum Company, Chicago, IL (US)

(21) Appl. No.: 11/626,751

(22) Filed: Jan. 24, 2007

(51) Int. Cl. B32B 13/00; C04B 11/00

(52) U.S. Cl. 428/220; 106/783; 106/711; 106/779; 106/780; 106/778

(57) ABSTRACT

Gypsum products and method for the preparation thereof are disclosed. The gypsum products comprise an interlocking matrix of set gypsum that is formed from a composition comprising calcined gypsum, water and acoustical tile.

### BACKGROUND OF THE INVENTION

Many well known useful products contain calcium sulfate dihydrate, also referred to as set gypsum, as a significant component. For example, set gypsum is the major component of paper-faced gypsum boards employed in typical wallboard construction of interior walls and ceilings of buildings, as described, for example, in U.S. Pat. Nos. 4,009,062 and 2,985,219. Set gypsum is also the major component of gypsum/cellulose fiber composite boards and products, as described, for example, in U.S. Pat. No. 5,320,677. Products that fill and smooth the joints between edges of gypsum boards also often contain major amounts of calcium sulfate hemihydrate that, after being applied, sets to form calcium sulfate dihydrate, as illustrated, for example, by U.S. Pat. No. 3,297,601. Acoustical tiles useful in suspended ceilings can contain a significant amount of set gypsum, as described, for example, in U.S. Pat. Nos. 5,395,438 and 3,246,063. Traditional plasters, such as those used to create plaster-surfaced internal building walls, for example, usually depend mainly on the formation of set gypsum. Further, many specialty materials, such as materials useful for modeling and mold-making and that can be precisely machined, for example, as described in U.S. Pat. No. 5,534,059, also contain significant amounts of set gypsum.

Set gypsum-containing compositions are typically prepared by forming a mixture of calcined gypsum, and water. Calcined gypsum is known in many forms, as described below. A variety of other components also can be included in the mixture, as is well known to those skilled in the art of gypsum wallboard manufacturing, for example, including fillers, accelerator set retarders, binders, and the like. The mixture is cast into a desired shape or onto a surface and then allowed to harden to form set gypsum by reaction of the calcined gypsum with water to form a matrix of crystalline hydrated gypsum or calcium sulfate dihydrate. Mild heating is employed to drive off free or un-reacted water to yield a dry product. It is the desired hydration of the calcined gypsum that enables the formation of an interlocking matrix of set gypsum crystals, thereby imparting strength to the gypsum structure in the set gypsum-containing composition.

Although set gypsum is often the major component of set gypsum-containing compositions, fillers also play an important role in these products. In the case of wallboard, which is often referred to as drywall, a variety of fillers can be utilized for a variety of purposes, such as providing added strength and/or reduced density. For example, lightweight fillers, such as paper fiber, are often employed to reduce the density of wallboard. Fillers can also be employed to reduce the cost of the drywall when they are selected from readily available and inexpensive materials. This cost reduction can be achieved when the added filler reduces the amount or quantity of other more expensive materials that would otherwise need to be added.

Although there are currently a variety of commonly employed fillers, there is a continuing effort to find fillers that can reduce the cost of the set gypsum-containing compositions, while maintaining the commercial utility of these products. The identification and use of waste materials suitable for this purpose would be ideal, especially if such materials are readily available, are not otherwise readily recyclable, and do not compromise the commercial utility or integrity of the set-gypsum containing composition. Using fillers derived from such waste materials would not only reduce the cost of the set-gypsum composition, but would also serve as a means of recycling, thereby decreasing the amount of material that would likely otherwise end-up in landfills.

The present invention provides set gypsum-containing compositions, including a wallboard that has an interlocking matrix of set gypsum formed from a mixture comprising calcined gypsum, water and filler, wherein filler includes acoustical tile. Use of acoustical tile filler, including acoustical tile that is otherwise scrap, allows for the production of set gypsum-containing products, including wallboard without compromising the integrity of the final product. These and other objects and advantages of the present invention will be apparent to those skilled in the art in view of the detailed description of this invention.

### BRIEF SUMMARY OF THE INVENTION

The present invention provides a set gypsum-containing product, such as wallboard, and methods for the preparation thereof. Advantageously, the set gypsum-containing product of the invention includes acoustical tile as filler.

In one aspect, the present invention provides a gypsum wallboard having an interlocking matrix of set gypsum, wherein the wallboard is formed from a composition including calcined gypsum, water and filler in the form of acoustical tile. Acoustical tile filler is desirably included in the composition mixture used to form the set gypsum-containing product in an amount such that the integrity and utility of the wallboard is not compromised. As is known to those skilled in the wallboard art, wallboard integrity, quality and utility depend on the overall characteristics of the board, including nail pull resistance, modulus of rupture (MOR) in bending in the machine direction, and MOR in the cross direction, which can be quantified according to ASTM standards. Other factors such as density, void volume, score and snap characteristics and the like are also of interest. However, the inventors have found that acoustical tile can be included in the mixture used to form wallboard while maintaining or exceeding acceptable standards for nail pull and MOR. Nail pull and MOR also depend, as is known, on the nominal thickness of the gypsum wallboard, which is typically manufactured and sold commercially as 6.4 mm (¼ inch), 9.5 mm (⅜ inch), 12.7 mm (½ inch), 15.9 mm (⅝ inch), 19.1 mm (¾ inch) and 25.4 mm (1 inch) wallboard. Thus, in accordance with the invention, acoustical tile is included in the mixture from which the set gypsum-containing product, including wallboard, is formed such that the nail pull resistance, and the MOR of the wallboard in the machine and in the cross directions are, as related to the thickness of the wallboard, according to the following:

(i) for 6.4 mm (114 inch) wallboard, a nail pull resistance of at least 160 N (36 lbf), a MOR in the machine direction of at least 8880 kPa (1288 psi), and a MOR in the cross direction of at least 3089 kPa (448 psi);

(ii) for 9.5 mm (⅜ inch) wallboard, a nail pull resistance of at least 249 N (56 lbf), a MOR in the machine direction of at least 6605 kPa (958 psi), and a MOR in the cross direction of at least 2234 kPa (324 psi);

(iii) for 12.7 mm (½ inch) wallboard, a nail pull resistance of at least 343 N (77 lbf), a MOR in the machine direction of at least 5164 kPa (749 psi), and a MOR in the cross direction of at least 1737 kPa (252 psi);

(iv) for 15.9 mm (⅝ inch) wallboard, a nail pull resistance of at least 387 N (87 lbf, a MOR in the machine direction of at least 4544 kPa (659 psi), and a MOR in the cross direction of at least 1420 kPa (206 psi);

(v) for 19.1 mm (¾ inch) wallboard, a nail pull resistance of at least 431 N (97 lbf), a MOR in the machine direction of at least 3585 kPa (520 psi), and a MOR in the cross direction of at least 1200 kPa (174 psi); and

(vi) for 25.4 mm (1 inch) wallboard, a nail pull resistance of at least 458 N (103 lbf), a MOR in the machine direction of at least 2337 kPa (339 psi), and a MOR in the cross direction of at least 931 kPa (135 psi).

Advantageously, the utilization of scrap acoustical tile provides a cheap and readily available filler, thereby reducing the cost of production while also recycling a potential waste product that would otherwise likely require disposal in a landfill.

The present invention further provides a method for preparing gypsum wallboard having an interlocking matrix of set gypsum. The method involves forming a mixture including calcined gypsum, water, and acoustical tile and casting the mixture to form gypsum wallboard. The acoustical tile is included in the mixture in an amount such that the wallboard has a nail pull resistance, a MOR in the machine direction, and a MOR in the cross direction, as related to the thickness of the wallboard, as described above for each size of wallboard in (i) through (vi).

### DETAILED DESCRIPTION OF THE INVENTION

The present invention provides a set gypsum-containing product formed from a mixture which includes calcined gypsum, water and acoustical tile. In a preferred embodiment, the present invention provides a gypsum wallboard comprising an interlocking matrix of set gypsum, wherein the wallboard is formed from a mixture comprising calcined gypsum, water, and acoustical tile.

As will be appreciated by those skilled in the art, calcined gypsum is known in many forms. For example, calcined gypsum can be fibrous or non-fibrous. Non-fibrous calcined gypsum refers to calcined gypsum that can be prepared according to known prior art processes in a calciner, such as, for example, a kettle or rotary calciner, at normal atmospheric pressure as described in U.S. Pat. No. 2,341,426. Calcined gypsum can also be in the form of alpha calcium sulfate hemihydrate, beta calcium sulfate hemihydrate, water-soluble calcium sulfate anhydrite, or mixtures thereof. Fibrous calcined gypsum is described, for example, in U.S. Pat. Nos. 4,029,512 and 5,041,333.

In another aspect of the present invention, one or more enhancing materials can be included in the composition comprising calcined gypsum, water, and acoustical tile used to form the set gypsum-containing product, such as wallboard. Enhancing materials preferably are used to promote strength and/or dimensional stability, such as, for example, by minimizing shrinkage due to drying stresses that can occur, for example, during kiln drying of the set gypsum composition, as described in U.S. Pat. Nos. 6,409,824 and 6,387,172. By way of example, the enhancing materials impart resistance to deformation, and, in particular, sagging, that advantageously provides a set gypsum product with a more stable form over time. For example, the sag resistance imparted by the enhancing material is beneficial in overcoming the presence of certain salts, such as chloride salts, that may be present as impurities in the aqueous calcined gypsum mixture and which might otherwise lead to sag during use. In addition, the enhanced dimensional stability, including resistance to shrinkage, imparted by the enhancing materials is beneficial, for example, in resisting drying stresses, and hence shrinkage, during preparation, as well as in resisting dimensional expansion in use.

Other additives can be included in the composition of calcined gypsum, water and acoustical tile used to form the set gypsum-containing products in accordance with the invention, including wallboard. Such additives include, but are not limited to: reinforcing additive; binder, including polymers such as latex; expanded perlite; air voids formed by an aqueous foam; starch such as a pregelatinized starch; or fibrous mat. Various combinations of these optional additives can be included in the composition used to form the set gypsum composition. Further, these additives can be included in gypsum compositions that also include one or more of enhancing materials. As described in U.S. Pat. No. 6,342,284, other conventional additives also can be employed in the practice of the invention. Such conventional additives can be added in customary amounts to impart desirable properties and to facilitate manufacturing. Examples of such additives include aqueous foam, set accelerators, set retarders, recalcination inhibitors, binders, adhesives, dispersing aids, leveling or non-leveling agents, thickeners, bactericides, fungicides, pH adjusters, colorants, reinforcing materials, fire retardants, water repellants, fillers and mixtures thereof.

Although numerous types of acoustical tile are compatible with the present invention, the acoustical tile must be used in an amount that does not compromise the integrity of the set gypsum-containing product and in particular the nail pull resistance and MOR of the wallboard in both the machine and cross directions. Accordingly, it is contemplated that a wide variety of acoustical tile, each with a wide variety of components and properties will be useful in the practice of the invention. For example, cast acoustical tile, as described in U.S. Pat. No. 1,769,519, is useful in the practice of the invention. More preferably, wet-felted acoustical tile is used to make set gypsum-containing products, including wallboard.

Preferably acoustical tile useful in the practice of the invention is scrap acoustical tile. Scrap acoustical tile includes tile that is intended to be recycled. By way of illustration and not in limitation of the present invention, recycled acoustical tile includes acoustical tile that has been installed in a structure, but for any number of reasons, including renovation or demolition of the structure, has been removed. However, recycled acoustical tile can also include acoustical tile that was never installed or acoustical tile that did not meet required quality or commercial standards. Furthermore, recycled acoustical tile includes tile that was damaged or broken during production, shipping or installation. Thus, recycled acoustical tile includes any acoustical tile that is made as a tile and which is later ground, hammer milled or prepared in any way for addition to a composition including calcined gypsum.

Acoustical tile includes a multitude of components, which can be present in numerous combinations and amounts. Common components of acoustical tile include, for example; mineral wool, glass wool, or slag wool fiber; starch, such as corn starch; paper fiber, including recycled post consumer paper; clay, including kaolin ball clay; retention aids; perlite, including expanded perlite; surfactants; defoamers; polymers, such as styrene and/or acrylic latex, acrylamide copolymer, vinyl acetate, and ethylene vinyl acetate; crystalline forms of silica, such as quartz; calcium carbonate; and reclaim. Reclaim itself is acoustical tile that has been recycled. One skilled in the art will understand that these and other components are present in varying amounts and combinations, including those amounts and combinations discussed herein in a wide variety of acoustical tile. Known, wet-felted acoustical tile is comprised of: mineral wool, corn starch and paper fiber; mineral wool, corn starch, latex and paper fiber; mineral wool, corn starch, latex, paper fiber, and perlite; and the like. In a preferred embodiment of the present invention, acoustical tile used to make the mixture used to form the set gypsum-containing product is wet-felted.

In one aspect of the invention, the acoustical tile includes from about 5 wt. % to about 93 wt. % mineral wool, from about 2 wt. % to about 20 wt. % corn starch, and from about 0.1 wt. % to about 20 wt. % paper fiber. Preferably, the acoustical tile includes from about 15 wt. % to about 60 wt. % mineral wool, from about 2 wt. % to about 15 wt. % corn starch, and from about 5 wt. % to about 20 wt. % paper fiber. More preferably, the acoustical tile includes from about 25 wt. % to about 45 wt. % mineral wool, from about 6 wt. % to about 12 wt. % corn starch, and from about 10 wt. % to about 20 wt. % paper fiber.

In another aspect of the invention, the acoustical tile includes from about 5 wt. % to about 93 wt. % mineral wool, from about 2 wt. % to about 20 wt. % corn starch, from about 0.1 wt. % to about 5 wt. % latex, and from about 0.1 wt. % to about 20 wt. % paper fiber. Preferably, the acoustical tile includes from about 15 wt. % to about 60 wt. % mineral wool, from about 2 wt. % to about 15 wt. % corn starch, from about 0.5 wt. % to about 5 wt. % latex, and from about 5 wt. % to about 20 wt. % paper fiber. More preferably, the acoustical tile includes from about 25 wt. % to about 45 wt. % mineral wool, from about 6 wt. % to about 12 wt. % corn starch, from about 0.5 wt. % to about 3 wt. % latex, and from about 10 wt. % to about 20 wt. % paper fiber.

In yet another aspect, the acoustical tile includes from about 5 wt. % to about 93 wt. % mineral wool, from about 2 wt. % to about 20 wt. % corn starch, from about 0.1 wt. % to about 5 wt. % latex, from about 0.01 wt. % to about 50 wt. % perlite, and from about 0.1 wt. % to about 20 wt. % paper fiber. Preferably, the acoustical tile includes from about 15 wt. % to about 60 wt. % mineral wool, from about 2 wt. % to about 15 wt. % corn starch, from about 0.5 wt. % to about 5 wt. % latex, from about 10 wt. % to about 50 wt. % perlite, and from about 5 wt. % to about 20 wt. % paper fiber. More preferably, the acoustical tile includes from about 25 wt. % to about 45 wt. % mineral wool, from about 6 wt. % to about 12 wt. % corn starch, from about 0.5 wt. % to about 3 wt. % latex, from about 20 wt. % to about 30 wt. % perlite, and from about 10 wt. % to about 20 wt. % paper fiber.

A variety of methods can be used for preparing the acoustical tile and adding it to the composition of calcined gypsum and water. For example, a preferred process of preparing the acoustical tile involves reducing the tile or tile fragments into particles of a desired size, preferably 862 mm (⅛ inch) and then conveying and metering this material into a drywall feed. The process of size reduction can be achieved by any method known in the art, including hammer milling and/or grinding, either with or without a sizing screen. A sizing screen allows particles smaller than or approximately equal to the openings in the screen to pass. Thus a 862 mm (⅛ inch) screen will produce particulate ranging in size from 862 mm (⅛ inch) or smaller. The preparation of the acoustical tile preferably begins with dry acoustical tile.

Varying amounts of acoustical tile can be added to the composition from which the wallboard is formed. For example, the acoustical tile can be added in an amount ranging from about 0.01 wt. % to about 7 wt. %, based on the weight of calcined gypsum. Preferably, the acoustical tile is added in an amount ranging from about 0.05 wt. % to about 7 wt. %, more preferably, in an amount ranging from about 0.05 wt. % to about 5 wt. %, or even more preferably, in an amount ranging from about 0.05 wt. % to about 3 wt. %, based on the weight of calcined gypsum.

Addition of the prepared acoustical tile is preferably achieved using a continuous process, which is particularly advantageous for improved and uniform mixing and metering of material, as compared to a traditional batch process. This continuous process is also more compatible with existing continuous manufacturing processes for wallboard manufacture.

In a preferred aspect of the invention, the gypsum wallboard includes an interlocking matrix of set gypsum that is formed from a composition including calcined gypsum, water and acoustical tile, such that the wallboard has a nail pull resistance, a MOR in the machine direction, and a MOR in the cross direction, as related to the thickness of the wallboard, according to Table 1.

TABLE 1
Properties of Useful Wallboard

| Wallboard | | Nail Pull | | MOR in the | | MOR in the Cross | |
|---|---|---|---|---|---|---|---|
| Thickness | | Resistance (lbf) | | Machine Direction | | Direction (psi) | |
| (in.) | | of at least: | | (psi) of at least: | | of at least: | |
| 6.4 | mm | 160 | N | 8880 | kPa | 3089 | kPa |
| (¼ | in.) | (36 | lbf) | (1288 | psi) | (448 | psi) |
| 9.5 | mm | 249 | N | 6605 | kPa | 2234 | kPa |
| (⅜ | in.) | (56 | lbf) | (958 | psi) | (324 | psi) |
| 9.5 | mm | 343 | N | 5164 | kPa | 1737 | kPa |
| (½ | in.) | (77 | lbf) | (749 | psi) | (252 | psi) |
| 12.7 | mm | 357 | N | 4544 | kPa | 1420 | kPa |
| (⅝ | in.) | (87 | lbf) | (659 | psi) | (206 | psi) |
| 19.1 | mm | 431 | N | 3585 | kPa | 1200 | kPa |
| (¾ | in.) | (97 | lbf) | (520 | psi) | (174 | psi) |
| 25.4 | mm | 458 | N | 2337 | kPa | 931 | kPa |
| (1 | in.) | (103 | lbf) | (339 | psi) | (135 | psi) |

In a further aspect of the invention, gypsum wallboard having an interlocking matrix of set gypsum is formed from a composition including calcined gypsum, water and acoustical tile, such that the acoustical tile is added in an amount that does not adversely affect the commercial viability of the wallboard. Wallboard of the invention is useful for construction purposes and other uses for which wallboard is normally employed.

Wallboard of the present invention can be produced using any known technique that is known in the art for producing wallboard. In a preferred embodiment, the inventive wallboard is prepared by forming a mixture including water, calcined gypsum, and acoustical tile and casting the mixture to form gypsum wallboard having a nail pull resistance, a MOR in the machine direction, and a MOR in the cross direction, as related to the thickness of the wallboard, according to Table 1.

Once the acoustical tile has been prepared for addition, it can be added at a variety of points in the wallboard manufacturing process. For example, the prepared acoustical tile can be added in combination with recycled wallboard scrap, which is frequently used in the wallboard process. In this case, acoustical tile is introduced to raw gypsum material at the beginning of the raw material preparation step for wallboard manufacture. Other points of addition are discussed in the Examples and still others will be readily apparent to those skilled in the art.

Acoustical tile can be added in any order to the composition from which the wallboard is formed. For example, it can be dry blended with the calcined gypsum before the addition of water, it can be added to a composition of calcined gypsum and water, and/or it can be blended with water prior to the addition of the calcined gypsum.

The following examples further illustrate the invention but, of course, should not be construed as in any way limiting its scope.

### EXAMPLE 1

Production Line Gypsum Wallboard Nail Pull Resistance

This example and the data provided herein illustrate the beneficial use of acoustical tile in gypsum wallboard. The nail pull and MOR values of gypsum wallboard of the present invention are not adversely affected by the inclusion of acoustical tile in the composition comprising calcined gypsum and water used to form gypsum wallboard and the wallboard of the present invention is a commercially acceptable product useful for construction and for other purposes for which wallboard is utilized. This is illustrated by a comparison of the nail pull resistance, and board weights of the controls, as shown in Entries 1 and 2 of Table 3, to the wallboard in accordance with the invention, Entries 3-11. Table 3 provides data for 12.7 mm (½ inch) production line wallboard. Similar results are provided in Table 4, for 9.5 mm (⅜ inch) production line gypsum wallboard.

Although numerous techniques can be employed to prepare wallboard of the invention, the following method was used to prepare the production line wallboard of Examples 1, 2 and 3. Dry acoustical tile was received at the plant and conveyed to a primary reduction device. Although a variety of devices can be used for this purpose, in this case the primary reduction device employed counter rotating screws. This process reduces the size of the acoustical tile and provides fragments that can be fed easily into a secondary or final reduction device. In this case, the fragments were approximately four-inch fragments.

The four-inch fragments were conveyed to a final reduction device. The final reduction device utilized a fixed hammer or swing hammer mill with a 9.5 mm (⅛ inch) sizing screen on the discharge. The fragments were then reduced in size by the hammer mill until the resulting particulate could fit through the 9.5 mm (⅛ inch) sizing screen and exit the hammer mill as an acoustical tile particulate. The acoustical tile particulate, which is a low bulk density material, was collected in a cyclone/baghouse system and was subsequently transferred either pneumatically, or via mechanical C tube conveyors, to a feeder for an acoustical tile-metering device. The acoustical tile-metering device consisted of a vertical tube with rotating pin rolls, and provided a controlled and accurate discharge of the acoustical tile particulate into a screw to feed the ground acoustical tile, stucco and other dry ingredients into a wallboard mixer. In the wallboard mixer, dry and wet ingredients were blended and after suitable mixing, were cast onto a continuous drywall forming line.

The production line gypsum wallboard, as analyzed in Examples 1, 2 and 3, was produced on a forming line running at a speed of 66 meters/min. (215 fpm). The particulate acoustical tile was added at 0.59 kg/min. (1.29 lb/min.) to achieve a 0.1% dosage. Approximately 581 kg/min. (1280 lb/min.) of a dry stucco and additional additive solids were mixed with water in the wallboard mixer and dispersed across the width of the forming line to achieve a final product with a thickness of 12.7 mm (½ inch) and a dry weight of 7.35 kg/m² (1500 lb/ms). After discharge from the wallboard mixer onto a moving paper sheet, an additional sheet was continuously applied to the top of the mixture and the stucco was allowed to react with the water to form a solid core prior to removal of excess water in a continuous dryer. The continuous ribbon of material was cut prior to the kiln and discharged from the kiln onto conveyors where final stacking was performed. The wallboard used in Examples 1, 2 and 3 was pulled from the stacks and cut into smaller samples, as required for mechanical testing.

The 12.7 mm (½ inch) and 9.5 mm (⅜ inch) wallboard described in Tables 3, 4, 5, 6 and 7 was prepared using RADAR 2310 acoustical wet felted ceiling tile at a variety of concentrations, based on the weight of calcined gypsum. The samples were analyzed using, among other things, nail pull resistance, which is a measure of the strength of the wallboard. This test measures the maximum force required to pull a nail with a head through the board until major cracking of the board occurs. The nail pull resistance test is carried out in accordance with ASTM C473.

Table 2 identifies the primary components of the acoustical tile A, as employed in Tables 3, 4, 5, 6 and 7.

TABLE 2
Acoustical Tile Components

| Components | Acoustical Tile A |
|---|---|
| Mineral Wool | 7–13% |
| Starch | 7–13% |
| Latex | 0–5% |
| Paper Fiber | 15–25% |
| Calcium Carbonate | 5–10% |
| Clay | 0–5% |
| Acrylamide Copolymer | 0–5% |
| Expanded Perlite | 50–60% |

TABLE 3
Production Line ½ Inch Gypsum Wallboard Nail Pull Resistance
and Board Weight

| | Acoustical Tile (% | | | | |
|---|---|---|---|---|---|
| | wt. by weight of | Nail Pull | | Board Weight | |
| Entry Nos. | calcined gypsum) | Resistance (lbf) | | (lb/msf) | |
| 1 | Control (0) | 406.2 | N | 7.879 | kg/m² |
| | | (91.32 | lbf) | (1608 | lb/msf) |
| 2 | Control (0) | 376.6 | N | 7.820 | kg/m² |
| | | (84.66 | lbf) | (1596 | lb/msf) |
| 3 | A (0.1) | 383.1 | N | 7.923 | kg/m² |
| | | (86.12 | lbf) | (1617 | lb/msf) |
| 4 | A (0.1) | 370.0 | N | 7.860 | kg/m² |
| | | (83.18 | lbf) | (1604 | lb/msf) |
| 5 | A (0.1) | 412.4 | N | 7.914 | kg/m² |
| | | (92.72 | lbf) | (1615 | lb/msf) |
| 6 | A (0.1) | 377.1 | N | 7.879 | kg/m² |
| | | (84.78 | lbf) | (1608 | lb/msf) |
| 7 | A (0.1) | 383.3 | N | 7.850 | kg/m² |
| | | (86.16 | lbf) | (1602 | lb/msf) |
| 8 | A (0.2) | 387.3 | N | 7.820 | kg/m² |
| | | (87.06 | lbf) | (1596 | lb/msf) |
| 9 | A (0.2) | 388.2 | N | 7.904 | kg/m² |
| | | (87.28 | lbf) | (1613 | lb/msf) |
| 10 | A (0.2) | 384.2 | N | 7.904 | kg/m² |
| | | (86.38 | lbf) | (1613 | lb/msf) |
| 11 | A (0.2) | 402.9 | N | 7.904 | kg/m² |
| | | (90.58 | lbf) | (1613 | lb/msf) |

TABLE 4
Production Line ⅜ Inch Gypsum Wallboard Nail Pull Resistance
And Board Weight

| | Acoustical | | | | | | |
|---|---|---|---|---|---|---|---|
| | Tile (% wt. | | | | | | |
| | by weight | Nail Pull | | Board | | | |
| Entry | of calcined | Resistance | | Weight | | Dry Density | |
| Nos. | gypsum) | (lbf) | | (lb/msf) | | (lbs/ft.³) | |
| 1 | Control (0) | 511.1 | N | 7.056 | kg/m² | 752.7 | kg/m³ |
| | | (114.9 | lbf) | (1440 | lb/msf) | (46.99 | lbs/ft³) |
| 2 | A (0.1) | 526.2 | N | 6.983 | kg/m² | 751.4 | kg/cm³ |
| | | (118.3 | lbf) | (1425 | lb/msf) | (46.92 | lbs/ft³) |
| 3 | A (0.1) | 537.3 | N | 7.027 | kg/m² | 749.5 | kg/cm³ |
| | | (120.8 | lbf) | (1434 | lb/msf) | (46.79 | lbs/ft³) |

### EXAMPLE 2

Production Line Gypsum Wallboard Flexural Strength and Board Weight

This example and the data provided herein illustrate that the wallboard is not adversely affected by the use of acoustical tile and that the wallboard is a commercially acceptable product useful for construction and other purposes for which wallboard is utilized. This is evidenced, for example, by comparison of the flexural strengths, or breaking strength, which is the load required to break a wallboard sample, and board weights of the controls, as shown in Entries 1 and 2 of Table 5, to the wallboard in accordance with the invention, Entries 3-11. Similar results are provided in Table 6, for ⅜ inch production line gypsum wallboard.

Wallboard formed from a composition including acoustical tile was prepared on a typical full-scale production line in a gypsum board manufacturing facility, as described in Example 1.

TABLE 5
Production Line ½ Inch Gypsum Wallboard Flexural Strength and
Board Weight

| | Acoustical | | | | |
|---|---|---|---|---|---|
| | Tile | | | | |
| | (% wt. by | Flexural Strength (lbf) | | | |
| | weight of | Machine | | Cross Machine | |
| Entry | calcined | Direction | | Direction | |
| Nos. | gypsum) | Face Up | Face Down | Face Up | Face Down |
| 1 | A (0) | 814.83 N | 853.74 N | 255.2 N | 244.3 N |
| | | (183.18 lbf) | (191.93 lbf) | (57.37 lbf) | (54.93 lbf) |
| 2 | A (0) | 772.30 N | 857.66 N | 249.4 N | 233.5 N |
| | | (173.62 lbf) | (192.81 lbf) | (56.06 lbf) | (52.50 lbf) |
| 3 | A (0.1) | 785.91 N | 787.06 N | 248.3 N | 221.8 N |
| | | (176.68 lbf) | (177.06 lbf) | (55.81 lbf) | (49.87 lbf) |
| 4 | A (0.1) | 756.46 N | 769.81 N | 244.1 N | 213.8 N |
| | | (170.06 lbf) | (173.06 lbf) | (54.87 lbf) | (48.06 lbf) |
| 5 | A (0.1) | 791.21 N | 790.67 N | 257.7 N | 224.6 N |
| | | (177.87 lbf) | (177.75 lbf) | (57.93 lbf) | (50.50 lbf) |
| 6 | A (0.1) | 767.01 N | 819.27 N | 247.41 N | 261.6 N |
| | | (172.43 lbf) | (184.18 lbf) | (55.62 lbf) | (58.81 lbf) |
| 7 | A (0.1) | 771.77 N | 860.42 N | 247.4 N | 241.3 N |
| | | (173.50 lbf) | (193.43 lbf) | (55.62 lbf) | (54.25 lbf) |
| 8 | A (0.2) | 750.64 N | 840.14 N | 244.1 N | 237.4 N |
| | | (168.75 lbf) | (188.87 lbf) | (54.87 lbf) | (53.37 lbf) |
| 9 | A (0.2) | 749.53 N | 802.32 N | 256.3 | 236.3 N |
| | | (168.50 lbf) | (180.37 lbf) | (57.62 lbf) | (53.12 lbf) |
| 10 | A (0.2) | 783.69 N | 835.42 N | 255.5 N | 238.8 N |
| | | (176.18 lbf) | (187.81 lbf) | (57.43 lbf) | (53.68 lbf) |
| 11 | A (0.2) | 774.54 N | 858.20 N | 251.0 N | 240.2 N |
| | | (174.12 lbf) | (192.93 lbf) | (56.43 lbf) | (54.00 lbf) |

TABLE 6
Production Line ⅜ Inch Gypsum Wallboard Flexural
Strength and Board Weight

| | Acoustical Tile | | | | |
|---|---|---|---|---|---|
| | (% wt. by | | | | |
| | weight of | Flexural Strength (lbf) | | | |
| Entry | calcined | Machine Direction | | Cross Direction | |
| Nos. | gypsum) | Face Up | Face Down | Face Up | Face Down |
| 1 | A (0) | 569.24 N | 420.67 N | 180.29 N | 155.55 N |
| | | (127.97 lbf) | (94.57 lbf) | (40.53 lbf) | (34.97 lbf) |
| 2 | A (0.1) | 553.94 N | 477.12 N | 172.50 N | 162.58 N |
| | | (124.53 lbf) | (107.26 lbf) | (38.78 lbf) | (36.55 lbf) |
| 3 | A (0.1) | 538.77 N | 450.92 N | 169.66 N | 166.94 N |
| | | (121.12 lbf) | (101.37 lbf) | (38.14 lbf) | (37.53 lbf) |

### EXAMPLE 3

Production Line ½ Inch Gypsum Wallboard Modulus of Rupture and Nail Pull Resistance.

This example and the data provided herein illustrate that the product of the present invention is not adversely affected by the use acoustical tile and that the wallboard is a commercially acceptable product useful for construction and other purposes for which wallboard is utilized. This is illustrated, for example, by comparison of the Modulus of Rupture and nail pull resistance values of the controls, as shown in Entries 1 and 2 of Table 7, to wallboard in accordance with the invention, Entries 3-11.

The samples from which the data in Table 7 was collected were pulled from a wallboard production line, as described in Example 1. The samples were then cut to 3″ by 14,″ conditioned in a 70° F. 50% relative humidity room until constant weight, and tested over a 12″ span using an ATS universal testing machine. The nail pull resistance values were measured as described in Example 1, while the MOR values were otherwise measured as described in Example 5.

TABLE 7
Production Line ½ Inch Gypsum Wallboard Modulus of Rupture
and Nail Pull Resistance

| | Acoustical | | | | | | |
|---|---|---|---|---|---|---|---|
| | Tile (% wt. | | | | | | |
| | by weight | Modulus of Rupture (psi) | | | | Nail Pull | |
| Entry | of calcined | Machine | | Cross | | Resistance | |
| Nos. | gypsum) | Direction | | Direction | | (lbf) | |
| 1 | control (0) | 8785.64 | kPa | 2715.16 | kPa | 388.9 | N |
| | | (1274.25 | psi) | (393.80 | psi) | (87.43 | lbf) |
| 2 | control (0) | 7628.29 | kPa | 2421.92 | kPa | 391.4 | N |
| | | (1106.39 | psi) | (351.27 | psi) | (88.00 | lbf) |
| 3 | A (0.1) | 8559.63 | kPa | 2631.32 | kPa | 411.8 | N |
| | | (1241.47 | psi) | (381.64 | psi) | (92.59 | lbf) |
| 4 | A (0.1) | 8267.50 | kPa | 2269.96 | kPa | 396.0 | N |
| | | (1199.10 | psi) | (329.23 | psi) | (88.80 | lbf) |
| 5 | A (0.1) | 8426.29 | kPa | 2604.56 | kPa | 388.0 | N |
| | | (1222.13 | psi) | (377.76 | psi) | (87.23 | lbf) |
| 6 | A (0.1) | 8065.07 | kPa | 2609.46 | kPa | 420.0 | N |
| | | (1169.74 | psi) | (378.47 | psi) | (94.41 | lbf) |
| 7 | A (0.1) | 8194.00 | kPa | 2425.23 | kPa | 425.0 | N |
| | | (1188.44 | psi) | (351.75 | psi) | (95.55 | lbf) |
| 8 | A (0.2) | 7991.78 | kPa | 2600.15 | kPa | 404.6 | N |
| | | (1159.11 | psi) | (377.12 | psi) | (90.95 | lbf) |
| 9 | A (0.2) | 6777.96 | kPa | 4429.26 | kPa | 415.8 | N |
| | | (983.06 | psi) | (642.41 | psi) | (93.47 | lbf) |
| 10 | A (0.2) | 7938.90 | kPa | 2291.27 | kPa | 408.5 | N |
| | | (1151.44 | psi) | (332.32 | psi) | (91.83 | lbf) |
| 11 | A (0.2) | 5793.04 | kPa | 2360.83 | kPa | 411.7 | N |
| | | (840.21 | psi) | (342.41 | psi) | (92.55 | lbf) |

### EXAMPLE 4

This example and the following nail pull resistance values illustrate that the product of the present invention is not adversely affected by the use acoustical tile and that the wallboard is a commercially acceptable product useful for construction and other purposes for which wallboard is utilized. This is illustrated, for example, by comparison of the nail pull resistance of the control, as shown in Entry 1 of Table 9, to the wallboard in accordance with the invention, Entries 2-12.

The preparation of acoustical tile for bench-scale gypsum wallboard production was achieved through batch grinding. For example, small samples of approximately 20 grams were prepared using a small coffee grinder with a fixed cutting blade that rotated through the acoustical tile at high speed. The grinding was usually continued for 5 to 10 seconds to achieve a desired fineness or particle size as determined by visual inspection. The resulting material was then mixed with other dry drywall ingredients and added to a high shear blender. The required water was added to the blender and the blender was run for approximately a minute. The resulting slurry mix was poured into two-inch square cube molds and paper faced forms to generate samples for strength testing.

In Table 9, the nail pull resistances of wallboard samples, which were prepared in a laboratory on a bench scale, were compared with control wallboard.

Table 8 identifies the primary components of the acoustical tiles B-E as employed in Tables 9 and 10.

TABLE 8
Acoustical Tile Components

| Entry | | Acoustical Tiles | | | |
|---|---|---|---|---|---|
| Nos. | Components | B | C | D | E |
| 1 | Mineral Wool | 85–95% | 45–55% | 85–95% | 7–13% |
| 2 | Starch | 1–5% | 7–13% | 1–5% | 7–13% |
| 3 | Latex | 0–5% | 0–5% | 0–5% | 0–5% |
| 4 | Paper Fiber | 0–5% | 5–10% | 0–5% | 15–25% |
| 5 | Calcium | 0–5% | 0–5% | 0–5% | 5–10% |
| | Carbonate | | | | |
| 6 | Clay | 0–5% | 15–25% | 0–5% | 0–5% |
| 7 | Acrylamide | 0–5% | 0–5% | 0–5% | 0–5% |
| | Copolymer | | | | |
| 8 | Expanded | 0–5% | 15–25% | 0–5% | 50–60% |
| | Perlite | | | | |

TABLE 9
Bench-Scale Gypsum Wallboard Nail Pull Resistance

| | |
|---|---|
| Acoustical Tile | |
| (% wt. by weight | Nail Pull Resistance |

| | of calcined | | | Standard |
|---|---|---|---|---|
| Entry Nos. | gypsum) | Mean (lbf) | | Deviation |
| 1 | Control (0.0) | 366.4 | N | 9.48 |
| | | (82.38 | lbf) | |
| 2 | A (.05) | 372.1 | N | 1.48 |
| | | (83.65 | lbf) | |
| 3 | A (1.0) | 367.9 | N | 3.55 |
| | | (82.71 | lbf) | |
| 4 | B (.05) | 380.0 | N | 4.95 |
| | | (85.42 | lbf) | |
| 5 | B (0.1) | 387.1 | N | 6.38 |
| | | (87.02 | lbf) | |
| 6 | B (1.0) | 369.4 | N | 7.61 |
| | | (83.05 | lbf) | |
| 7 | C (.05) | 347.6 | N | 15.45 |
| | | (78.15 | lbf) | |
| 8 | C (0.1) | 327.3 | N | 17.90 |
| | | (73.57 | lbf) | |
| 9 | C (1.0) | 309.3 | N | 19.44 |
| | | (69.53 | lbf) | |
| 10 | D (.05) | 369.70 | N | 9.69 |
| | | (83.11 | lbf) | |
| 11 | D (0.1) | 348.9 | N | 15.62 |
| | | (78.44 | lbf) | |
| 12 | D (1.0) | 377.7 | N | 4.35 |
| | | (84.91 | lbf) | |

### EXAMPLE 5

This example and the following modulus of rupture (MOR) values illustrate that the product of the present invention is not adversely affected by the use acoustical tile and that the wallboard is a commercially acceptable product useful for construction and other purposes for which wallboard is utilized. The integrity of the inventive wallboard is illustrated, for example, by comparison of the MOR values of the control, as shown in Entry 1 of Table 10, to the wallboard in accordance with the invention, Entries 2-12. The MOR values indicate the strength of a wallboard sample, taking into account, among other things, the length, width and thickness of the sample.

In this case, the wallboard samples were prepared on a bench-scale, as described in Example 4. The bench-scale samples were compared with similarly-prepared control wallboard.

Mechanical testing for flexural strength of samples was performed on a universal testing machine. Universal testing machines as used herein are available from both Instron Limited and ATS Universal. Panel samples having a three-inch width were supported on rods and loaded to failure as described in ASTM D1037, which provides details for static bending tests for composites to yield modulus of rupture (MOR). Samples having a twelve-inch width were analyzed pursuant to ASTM C473, which describes flexural tests for wallboard to yield flexural strength. Flexural strength, as described in ASTM C473, is commonly used at wallboard plants to monitor quality and MOR, as described in ASTM D1037, is more commonly used where higher precision and accuracy are required.

Flexural strength, or more accurately breaking strength, gives the load it takes to break a board sample and is commonly used to see if a change has occurred in manufactured wallboard products. Modulus of rupture, or MOR, is an estimate of the panel composite strength. The MOR eliminates common sources of errors, such as, for example, if the board is running thicker than its target, or nominal, thickness. Under such conditions, the breaking strength will show the thicker board to be stronger, with a greater breaking strength than the breaking strength observed for the nominal thickness board. If MOR is used, the thickness is incorporated into the strength calculation, as described in ASTM D1037, and both will have the same composite strength. Similarly, changes in the width dimension of the board are accounted for in the MOR calculation. For example, board cut to a narrower width will appear to have a lower breaking strength based on flexural strength. However, if MOR is used, the narrower width of the sample is accounted for in the calculation and the product strength value will not have changed due to the narrower width of the sample.

For flexural strength, ASTM C473, Standard Test Methods for Physical Testing of Gypsum Panel Products, section 11, gives cutting dimensions for test specimens and assumes that they are cut to 12 inches wide by 16 inches long and assumes that they are supported across a 14 inch span for testing and assumes a uniform thickness. The report of paragraph 11.7 says merely to report the breaking strength in pounds-force or Newtons.

For modulus of rupture in bending, ASTM D1037, Standard Test Methods for Evaluating Properties of Wood-Base Fiber and Particle Panel Materials, all dimensions are measured for each sample and the formula for MOR then multiplies the span and the recorded load at failure and a constant of 1.5, which is then divided by the width of the sample and the thickness factor squared.

TABLE 10
Bench-Scale Gypsum Wallboard Modulus of Rupture

| | Acoustical Tile | Modulus of Rupture (psi) | | |
|---|---|---|---|---|
| | (% wt. by weight of | | | Standard |
| Entry Nos. | calcined gypsum) | Mean | | Deviation |
| 1 | Control (0.0) | 3147 | kPa | 176.6 |
| | | (456.4 | psi) | |
| 2 | A (.05) | 4902 | kPa | 32.5 |
| | | (711.0 | psi) | |
| 3 | A (1.0) | 4282 | kPa | 27.3 |
| | | (621.1 | psi) | |
| 4 | B (.05) | 4162 | kPa | 170.5 |
| | | (603.6 | psi) | |
| 5 | B (0.1) | 4916 | kPa | 38.2 |
| | | (713.0 | psi) | |
| 6 | B (1.0) | 4837 | kPa | 96.0 |
| | | (701.6 | psi) | |
| 7 | C (.05) | 3145 | kPa | 155.0 |
| | | (456.2 | psi) | |
| 8 | C (0.1) | 4184 | kPa | 173.7 |
| | | (606.9 | psi) | |
| 9 | C (1.0) | 3762 | kPa | 201.2 |
| | | (545.6 | psi) | |
| 10 | D (.05) | 3360 | kPa | 165.7 |
| | | (487.3 | psi) | |
| 11 | D (0.1) | 2430 | kPa | 233 |
| | | (352.4 | psi) | |
| 12 | D (1.0) | 5248 | kPa | 71.2 |
| | | (761.1 | psi) | |

All references, including publications, patent applications, and patents, cited herein are hereby incorporated by reference to the same extent as if each reference were individually and specifically indicated to be incorporated by reference and were set forth in its entirety herein.

1. Gypsum wallboard comprising an interlocking matrix of set gypsum, said wallboard formed from a composition comprising calcined gypsum, water and acoustical tile, the wallboard having a nail pull resistance, a MOR in the machine direction, and a MOR in the cross direction, as related to the thickness of the wallboard, according to the following:
(i) for ¼ inch wallboard, a nail pull resistance of at least 36 lbf, a MOR in the machine direction of at least 1288 psi, and a MOR in the cross direction of at least 448 psi;
(ii) for ⅜ inch wallboard, a nail pull resistance of at least 56 lbf, a MOR in the machine direction of at least 958 psi, and a MOR in the cross direction of at least 324 psi;
(iii) for ½ inch wallboard, a nail pull resistance of at least 77 lbf, a MOR in the machine direction of at least 749 psi, and a MOR in the cross direction of at least 252 psi;
(iv) for ⅝ inch wallboard, a nail pull resistance of at least 87 lbf, a MOR in the machine direction of at least 659 psi, and a MOR in the cross direction of at least 206 psi;
(v) for ¾ inch wallboard, a nail pull resistance of at least 97 lbf, a MOR in the machine direction of at least 520 psi, and a MOR in the cross direction of at least 174 psi; and
(vi) for 1 inch wallboard, a nail pull resistance of at least 103 lbf, a MOR in the machine direction of at least 339 psi, and a MOR in the cross direction of at least 135 psi.

2. The wallboard of claim 1, wherein the wallboard has a thickness of ¼ inch, a nail pull of at least 36 lbf, and a MOR of at least 1288 psi in the machine direction, and a MOR of at least 448 psi in the cross direction.

3. The wallboard of claim 1, wherein the wallboard has a thickness of ⅜ inch, a nail pull of at least 56 lbf, and a MOR of at least 958 psi in the machine direction, and a MOR of at least 324 psi in the cross direction.

4. The wallboard of claim 1, wherein the wallboard has a thickness of ½ inch, a nail pull of at least 77 lbf, and a MOR of at least 749 psi in the machine direction, and a MOR of at least 252 psi in the cross direction.

5. The wallboard of claim 1, wherein the wallboard has a thickness of ⅝ inch, a nail pull of at least 87 lbf, and a MOR of at least 659 psi in the machine direction, and a MOR of at least 206 psi in the cross direction.

6. The wallboard of claim 1, wherein the wallboard has a thickness of ¾ inch, a nail pull of at least 97 lbf, and a MOR of at least 520 psi in the machine direction, and a MOR of at least 174 psi in the cross direction.

7. The wallboard of claim 1, wherein the wallboard has a thickness of 1 inch, a nail pull of at least 103 lbf, and a MOR of at least 339 psi in the machine direction, and a MOR of at least 135 psi in the cross direction.

8. The wallboard of claim 1, wherein the acoustical tile is wet-felted acoustical tile.

9. The wallboard of claim 8, wherein the wet-felted acoustical tile comprises mineral wool, corn starch, and paper fiber.

10. The wallboard of claim 9, wherein the wet-felted acoustical tile comprises from about 5 wt. % to about 93 wt. % mineral wool, from about 2 wt. % to about 15 wt. % corn starch, and from about 0.1 wt. % to about 20 wt. % paper fiber.

11. The wallboard of claim 8, wherein the wet-felted acoustical tile comprises mineral wool, corn starch, latex, and paper fiber.

12. The wallboard of claim 9, wherein the wet-felted acoustical tile comprises from about 5 wt. % to about 93 wt. % mineral wool, from about 2 wt. % to about 15 wt. % corn starch, from about 0.1 wt. % to about 5 wt. % latex, and from about 0.1 wt. % to about 20 wt. % paper fiber.

13. The wallboard of claim 8, wherein the wet-felted acoustical tile comprises mineral wool, corn starch, latex, paper fiber, and perlite.

14. The wallboard of claim 9, wherein the wet-felted acoustical tile comprises from about 5 wt. % to about 93 wt. % mineral wool, from about 2 wt. % to about 15 wt. % corn starch, from about 0.1 wt. % to about 5 wt. % latex, from about 0.1 wt. % to about 20 wt. % paper fiber, and from about 0.01 wt. % to about 50 wt. % perlite.

15. The wallboard of claim 1, wherein the amount of acoustical tile is from about 0.05 wt. % to about 5 wt. %, based on the weight of calcined gypsum.

16. The wallboard of claim 1, wherein the acoustical tile is a cast acoustical tile.

17. A method for preparing gypsum wallboard comprising an interlocking matrix of set gypsum, said method comprising:
forming a mixture comprising water, calcined gypsum, and acoustical tile; and
casting said mixture to form gypsum wallboard, the wallboard having a nail pull resistance, a MOR in the machine direction, and a MOR in the cross direction, as related to the thickness of the wallboard, according to the following:
(i) for ¼ inch wallboard, a nail pull resistance of at least 36 lbf, a MOR in the machine direction of at least 1288 psi, and a MOR in the cross direction of at least 448 psi;
(ii) for ⅜ inch wallboard, a nail pull resistance of at least 56 lbf, a MOR in the machine direction of at least 958 psi, and a MOR in the cross direction of at least 324 psi;
(iii) for ½ inch wallboard, a nail pull resistance of at least 77 lbf, a MOR in the machine direction of at least 749 psi, and a MOR in the cross direction of at least 252 psi;
(iv) for ⅝ inch wallboard, a nail pull resistance of at least 87 lbf, a MOR in the machine direction of at least 659 psi, and a MOR in the cross direction of at least 206 psi;
(v) for ¾ inch wallboard, a nail pull resistance of at least 97 lbf, a MOR in the machine direction of at least 520 psi, and a MOR in the cross direction of at least 174 psi;
(vi) for 1 inch wallboard, a nail pull resistance of at least 103 lbf, a MOR in the machine direction of at least 339 psi, and a MOR in the cross direction of at least 135 psi.

18. The method of claim 17, wherein the amount of acoustical tile in the mixture is from about 0.05 wt. % to about 5 wt. % based on the weight of calcined gypsum in the mixture.

19. The method of claim 17, wherein the acoustical tile is wet-felted acoustical tile.

20. The method of claim 18, wherein the wet-felted acoustical tile comprises mineral wool, corn starch, and paper fiber.

21. The method of claim 19, wherein the wet-felted acoustical tile comprises from about 5 wt. % to about 93 wt. % mineral wool, from about 2 wt. % to about 15 wt. % corn starch, and from about 0.1 wt. % to about 20 wt. % paper fiber.

22. The method of claim 18, wherein the wet-felted acoustical tile comprises mineral wool, corn starch, latex, and paper fiber.

23. The method of claim 21, wherein the wet-felted acoustical tile comprises from about 5 wt. % to about 93 wt. % mineral wool, from about 2 wt. % to about 15 wt. % corn starch, from about 0.1 wt. % to about 5 wt. % latex, and from about 0.1 wt. % to about 20 wt. % paper fiber.

24. The method of claim 18, wherein the wet-felted acoustical tile comprises mineral wool, corn starch, latex, paper fiber, and perlite.

25. The method of claim 23, wherein the wet-felted acoustical tile comprises from about 5 wt. % to about 93 wt. % mineral wool, from about 2 wt. % to about 15 wt. % corn starch, from about 0.1 wt. % to about 5 wt. % latex, from about 0.1 wt. % to about 20 wt. % paper fiber, and from about 0.01 wt. % to about 50 wt. % perlite.

26. A composition comprising calcined gypsum, water and acoustical tile and optimally other additives wherein when said composition is cast in ¼ inch wallboard, said wallboard has a nail pull resistance of at least 36 lbf, a MOR in the machine direction of at least 1288 psi, and a MOR in the cross direction of at least 448 psi.

27. The composition of claim 26, wherein the amount of acoustical tile is from about 0.01 wt. % to about 7 wt. % based on the weight of calcined gypsum.

28. The composition of claim 26, wherein the amount of acoustical tile is from about 0.05 wt. % to about 7 wt. % based on the weight of calcined gypsum.

29. The composition of claim 26, wherein the amount of acoustical tile is from about 0.01 wt. % to about 5 wt. % based on the weight of calcined gypsum.
